(19) United States
(12) Patent Application Publication
(10) Pub. No.: US 2012/0133488 A1
(43) Pub. Date: May 31, 2012

(54) RFID ELECTRONIC SHELF APPARATUS AND METHOD OF DETECTING POISITONS OF TAGS USING THE SAME

(75) Inventors: Gil Young CHOI, Daejeon-si (KR); Won Kyu CHOI, Daejeon-si (KR); Chan Won PARK, Daejeon-si (KR)

(73) Assignee: Electronics and Telecommunications Research Institute, Daejeon-si (KR)

(21) Appl. No.: 13/289,410

(22) Filed: Nov. 4, 2011

(30) Foreign Application Priority Data
Nov. 29, 2010 (KR) 10-2010-0119361

(51) Int. Cl. G06K 7/01; G06F 17/00

(52) U.S. Cl. 340/10.1; 235/375; 235/440

(57) ABSTRACT

A Radio Frequency IDentification (RFID) electronic shelf apparatus according to the present invention includes electronic shelf units stacked and each configured to have a plurality of reader antennas, a reader configured to recognize the electronic shelf units individually or in a group in order to recognize a tag included in the electronic shelf unit, and a position detection processing unit configured to group the plurality of reader antennas, included in the electronic shelf unit, and to obtain position information about the electronic shelf unit on which the tag is stacked based on tagging information provided by the reader. Accordingly, there are advantages of stability and accuracy in the transmission of information, reduced configuration costs, and efficient store management by solving the shadow region of an electric wave due to the stacking of items within an electronic shelf and the close arrangement of the items.

Priority to Korean patent application number 2010-0119361 filed on Nov. 29, 2010, the entire disclosure of which is incorporated by reference herein, is claimed.

### BACKGROUND OF THE INVENTION

1. Field of the Invention

The present invention relates to a Radio Frequency IDentification (RFID) electronic shelf apparatus and a method of detecting the positions of tags using the same and, more particularly, to an RFID electronic shelf apparatus and a method of detecting the positions of tags using the same, which are capable of checking inventory and detecting the positions of items by recognizing the items placed on RFID electronic shelves in a bundle.

2. Discussion of the Related Art

In general, an RFID electronic shelf apparatus has reader antennas mounted on a shelf structure and automatically performs the inventory management of items and the detection of the items by reading information about tags attached to the respective items which are arranged or stacked on shelves.

In a conventional RFID electronic shelf apparatus, a number of electronic shelves each having a narrow space are crowded, a number of items are stacked on each of the electronic shelves, and the items made of various packing materials are placed within the electronic shelf. Accordingly, the conventional RFID electronic shelf apparatus is problematic in that it is difficult to have a high recognition ratio through a conventional simple tagging method of recognizing tags.

### SUMMARY OF THE INVENTION

It is, therefore, an object of the present invention to provide an RFID electronic shelf apparatus and a method of detecting the positions of tags using the same, which are capable of solving the shadow region of an electric wave due to the stacking and close arrangements of items within shelves and of improving the stability and accuracy in the transmission of information by using UHF far-field-based reader antenna and near-field reader antenna techniques at the same time.

Another object of the present invention is to provide an RFID electronic shelf apparatus using localization algorithms for solving a problem that one tag is detected multiple and a method of detecting the positions of tags using the same.

The RFID electronic shelf apparatus according to an aspect of the present invention includes electronic shelf units stacked and each configured to have a plurality of reader antennas, a reader configured to recognize the electronic shelf units individually or in a group in order to recognize a tag included in the electronic shelf unit, and a position detection processing unit configured to group the plurality of reader antennas, included in the electronic shelf unit, and to obtain position information about the electronic shelf unit on which the tag is stacked based on tagging information provided by the reader.

The reader antennas may be chiefly installed on one or more of internal faces of the electronic shelf unit. Connection holes for connecting the reader antenna may be formed in the electronic shelf unit. Each of the electronic shelf units may include the ID of a shelf unit installation face, the ID of a shelf unit row number, and the ID of a shelf unit column number.

According to another aspect of the present invention, there is provided a method of detecting a position of a tag in an RFID electronic shelf apparatus including a plurality of electronic shelf units and having a plurality of reader antennas included in each of the electronic shelf units, including a tag inventory step, a step of determining whether simultaneous recognition for the tag has been generated in the plurality of electronic shelf units, and if, as a result of the determination, the simultaneous recognition for the tag is determined to have been generated in the electronic shelf units, acquiring position information about the tag by comparing counts that the electronic shelf units have recognized the tag.

If, as a result of the determination, the simultaneous recognition for the tag is determined not to have been generated in the electronic shelf units, information, indicating that the tag is placed in an electronic shelf unit that has recognized the tag, is stored. If the reader antennas which have recognized the tag are placed in the same electronic shelf unit, the tag is determined to be placed in the electronic shelf unit in which the reader antennas are installed.

If the number of the electronic shelf units which have recognized the tag more than once is plural, the number of times that the tag has been recognized is accumulated in each of the electronic shelf units which have recognized the tag more than once, and the tag is determined to be placed in an electronic shelf unit having the greatest cumulative number.

An RFID electronic shelf unit according to yet another aspect of the present invention includes the top, the bottom, and lateral faces configured to form the external appearance, at least one bottom reader antenna provided at the bottom, and at least one lateral reader antenna provided in at least one of the top and the lateral faces.

The bottom reader antenna may include at least one thin film-type antenna. The lateral reader antenna may include a dipole antenna. At least one connection hole for connecting the reader antennas is formed in at least one of the top and the lateral faces.

### BRIEF DESCRIPTION OF THE DRAWINGS

The above and other objects and features of the present invention will become apparent from the following description of preferred embodiments given in conjunction with the accompanying drawings, in which:

FIG. 1 shows the configuration of an RFID application system;

FIG. 2 shows a configuration of the application system of RFID electronic shelf apparatuses according to an embodiment of the present invention;

FIG. 3 shows the configuration of the RFID electronic shelf apparatus according to an embodiment of the present invention;

FIG. 4 is a perspective view of an RFID electronic shelf unit according to an embodiment of the present invention;

FIG. 5 is a diagram showing the arrangements of the electronic shelf units of the RFID electronic shelf apparatus and of reader antennas according to an embodiment of the present invention;

FIG. 6 is a diagram showing a tag position detection algorithm of the RFID electronic shelf apparatus according to an embodiment of the present invention;

FIG. 7 shows an operational procedure of the RFID electronic shelf apparatus according to an embodiment of the present invention;

FIG. 8 shows the configurations of RFID electronic shelf units and a numbering conceptual diagram according to an embodiment of the present invention; and

FIG. 9 is a diagram showing the user interface of the RFID electronic shelf apparatus according to an embodiment of the present invention.

### DETAILED DESCRIPTION OF THE EMBODIMENTS

The present invention will become more evident from a description of embodiments of the present invention in conjunction with the accompanying drawings, and thus a person having ordinary skill in the art to which the present invention pertains may readily implement the technical spirit of the present invention. Furthermore, in describing the present invention, a detailed description of the known functions and configurations will be omitted if it is deemed to make the gist of the present invention unnecessarily vague.

The embodiments of the present invention will now be described with reference to the accompanying drawings.

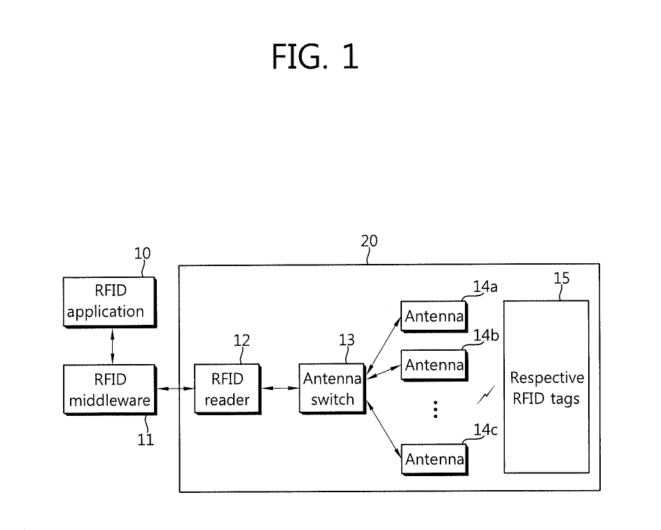

FIG. 1 shows the configuration of an RFID application system. Referring to FIG. 1, when a request for tagging information about items to which respective RFID tags 15 are attached is received through an RFID middleware 11 connected to an RFID application 10, the RFID reader 12 of the RFID application system 20 reads the tagging information through reader antennas 14a, 14b, and 14c and sends the read tagging information to the RFID application 10 via the RFID middleware 11.

If the number of reader antennas greater than the number of antenna ports provided by the RFID reader 12 is required, an antenna switch 13 may be used. The following embodiments of the present invention are based on the RFID application system.

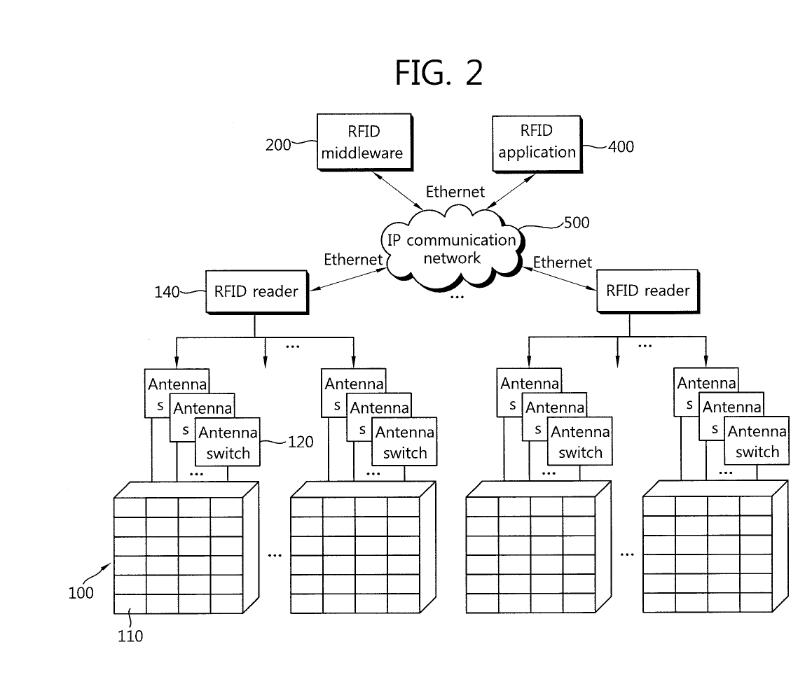

FIG. 2 shows a configuration of the application system of RFID electronic shelf apparatuses according to an embodiment of the present invention. In the embodiments of the present invention, a shelf module (i.e., a minimum unit to construct the shelf portion 100 of the RFID electronic shelf apparatus) is called an electronic shelf unit.

As shown in FIG. 2, the electronic shelf units 110 may be piled up or interconnected left and right in order to construct the shelf portion 100 of a desired size. The embodiments of the present invention are intended to construct the RFID electronic shelf apparatus for recognizing items on an item basis. One or more RFID reader antennas are disposed within each of the electronic shelf units 110. A plurality of the RFID electronic shelf apparatuses forms an RFID electronic shelf application system.

Each of the RFID electronic shelf apparatuses includes the electronic shelf units 110 each configured to have the one or more RFID reader antennas disposed therein and a plurality of antenna switches 120 configured to connect the reader antennas 130. The antenna switches 120 are connected to the antenna ports of an RFID reader 140.

The RFID electronic shelf apparatus according to the embodiment of the present invention may be extended in various forms using the plurality of electronic shelf units 110 according to a desired size, and the plurality of RFID readers 140 may be used in order to manage the RFID electronic shelf apparatuses. Communication between the RFID reader 140 and an RFID middleware 200 and between the RFID middleware 200 and an RFID application 400 is performed using Ethernet over an IP communication network 500.

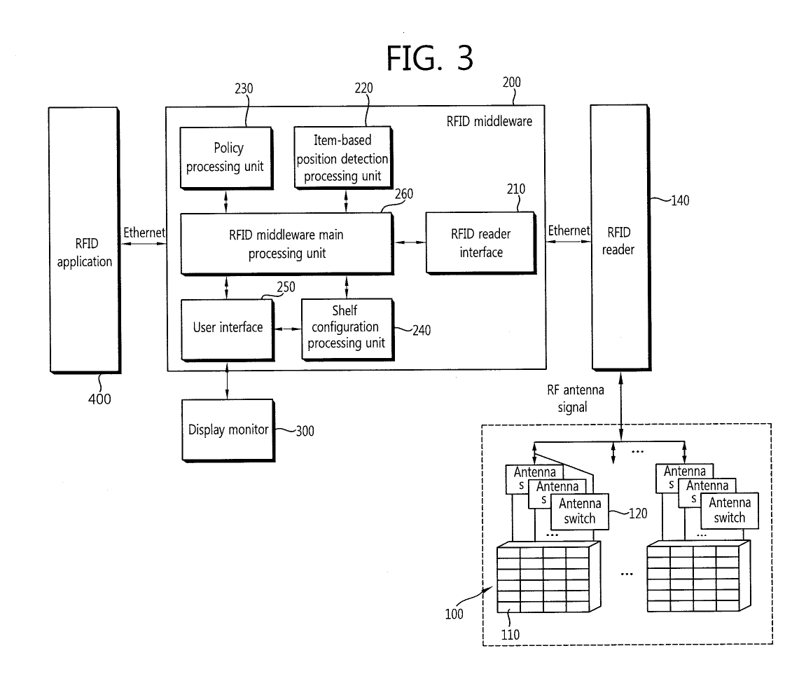

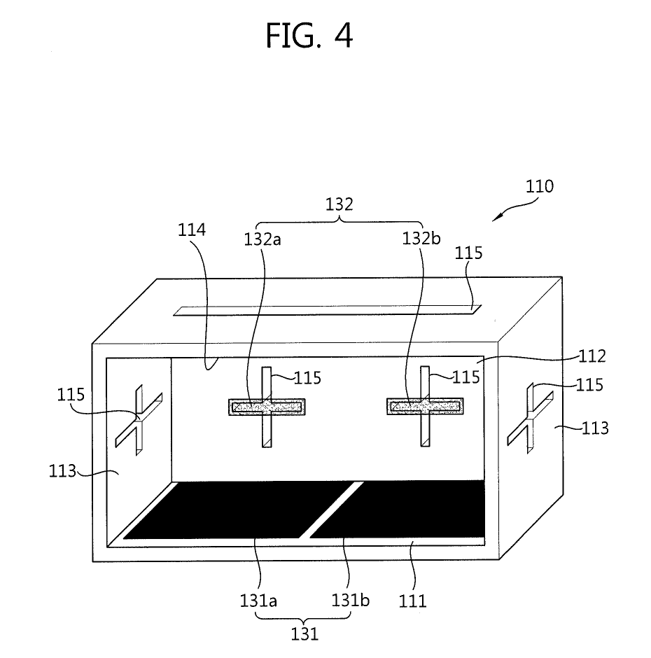

FIG. 3 shows the configuration of the RFID electronic shelf apparatus according to an embodiment of the present invention. As shown in FIG. 3, the RFID electronic shelf apparatus includes the RFID application 400, the RFID middleware 200, the RFID reader 140, and the shelf portion 100, including the plurality of electronic shelf units 110, the plurality of antenna switches 120, and the one or more RFID reader antennas 131, 132 (as shown in FIG. 4) embedded in each of the electronic shelf units 110. Items having respective tags attached thereto are arranged in the electronic shelf unit 110.

In the RFID electronic shelf apparatus according to the embodiment of the present invention, the tags are attached to the items arranged in the shelf portion 100, and the RFID reader 140 read pieces of tagging information about the items through the RFID reader antennas disposed within the shelf portion 100. When the RFID application 400 requests the collection of pieces of tagging information, the RFID middleware 200 receives the request, and the request is transferred from an RFID reader interface 210 to the RFID reader 140 through Ethernet.

The RFID reader 140 performs a tag inventory function. The RFID reader 140 collects pieces of tagging information about all the items arranged in the shelf portion 100 and sends the collected tagging information to the RFID middleware 200. The RFID middleware 200 processes (e.g., filters) the tagging information according to a desired form and sends the processed information to the RFID application 400.

The RFID middleware main processing unit 260 of the RFID middleware 200 performs a common RFID middleware function. An item-based position detection processing unit 220 performs a function of detecting the position of an item by analyzing tagging information and tagged antenna information. A policy processing unit 230 requests, from the RFID reader 140, a policy in which the RFID reader 140 collects the tagging information of an item and also manages the policy. A shelf configuration processing unit 240 performs a process of data-filing the configuration of the shelf portion 100 having various forms in actual stores. A user interface 250 performs a function of supporting the functions.

Each of the elements is described in more detail below. The RFID electronic shelf apparatus may have various configurations from a small scale to a large scale. Accordingly, in the case where tagging information is collected in a specific cycle according to the requirements of an application, the policy processing unit 230 defines and executes a policy in which collection time information is set so that tagging information can be collected at a desired point of time and provided.

The item-based position detection processing unit 220 performs a tag position detection algorithm. The tag position detection algorithm is used to solve problems occurring when a plurality of RFID reader antennas recognizes one item because the RFID reader antennas are closely disposed within the electronic shelf unit 110. The position of an item can be accurately detected by using the tag position detection algorithm. The tag position detection algorithm and the configuration of the electronic shelf unit related thereto are described later.

Meanwhile, a display monitor 300 connected to the user interface 250 is connected to the RFID middleware 200. Communication between the RFID application 400 and the RFID middleware 200 is performed using Ethernet over the IP communication network 500.

FIG. 4 is a perspective view of the RFID electronic shelf unit 110 according to an embodiment of the present invention. Referring to FIG. 4, the electronic shelf unit 110 is a minimum unit shelf module to construct the RFID electronic shelf apparatus. A user easily implements the shelf portion 100 of a desired size by piling, extending, and connecting the electronic shelf units 110 up and down and left and right.

If only one reader antenna is disposed at the bottom of the electronic shelf unit 110, flexibility in the size of the electronic shelf unit may be low and thus the RFID reader 140 may not accurately tag all items because of various environments, such as a form of the items stacked within the electronic shelf unit 110, the packing materials of the items, a large number of stacking layers, and crowded items.

In order to overcome the problem, in the embodiment of the present invention, the electronic shelf unit 110 is constructed to minimize the shadow region of an electric wave and provide a high recognition ratio by mounting one or more reader antennas 131 and 132 on the surface of an internal wall, including the bottom 111 of the electronic shelf unit 110. Although the one or more reader antennas 131 and 132 are used as described above, the problem of the recognition ratio may not be fully solved. In order to avoid the problem, the position to which a tag is attached or the type of a tag or both need to be well matched with the reader antennas 131 and 132 according to the form of each item.

In order to satisfy the above requirements, the electronic shelf unit 110 according to the embodiment of the present invention has a rectangular parallelepiped structure having the front opened and includes a plurality of thin film-type bottom reader antennas 131a and 131b disposed at the bottom 111 of the internal wall. Each of the thin film-type bottom reader antennas 131a and 131b is mounted at the bottom of the electronic shelf unit 110 in one or more square forms so that the size of the electronic shelf unit 110 can be flexibly reduced or expanded.

FIG. 4 shows an embodiment in which the two thin film-type bottom reader antennas 131a and 131b are mounted at the bottom 111. In this embodiment, a small-sized lateral reader antenna 132, such as dipole antennas, is attached on the rear lateral face 112 of an internal wall of the electronic shelf unit 110 and configured to recognize items stacked in the electronic shelf unit 110. The one or more lateral reader antennas 132 may be installed. FIG. 4 shows an embodiment in which two lateral reader antennas 132a and 132b are mounted on the rear lateral face 112.

Meanwhile, the electronic shelf unit 110 according to the embodiment of the present invention has a module structure in which a number of the bottom reader antennas 131 (i.e., a basic unit) can be attached according to the size. The size of the electronic shelf unit 110 may be controlled according to circumstances.

Connection holes 115, each having a cross (+) or straight (−) form, are formed on the remaining four faces (i.e., the rear lateral face 112, both lateral faces 113, and an upper lateral face 114) other than the bottom 111 and the opened front and configured to secure spaces for connecting the lateral reader antennas 132 and connectors so that the position where the lateral reader antenna 132 is disposed can be freely controlled.

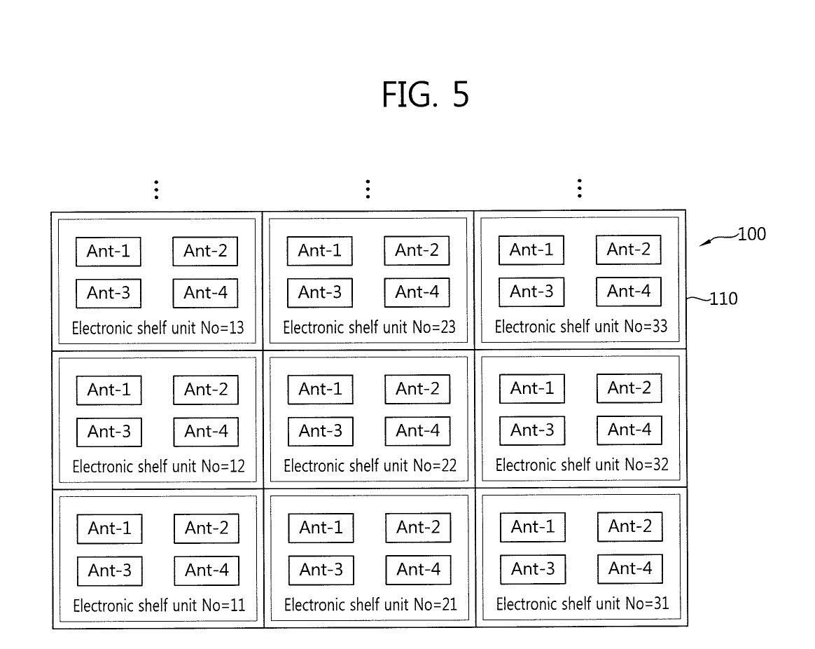

FIG. 5 is a diagram showing the arrangements of the electronic shelf units of the RFID electronic shelf apparatus and of the reader antennas according to an embodiment of the present invention. As shown in FIG. 5, one or more reader antennas Ant-1, Ant-2, Ant-3, and Ant-4 are disposed within each of the plurality of electronic shelf units 110 constituting the shelf portion 100 in order to minimize the shadow region of an electric wave. The electronic shelf units 110 have unique shelf unit numbers.

In FIG. 5, each of the electronic shelf units 110 is illustrated to have the four reader antennas Ant-1, Ant-2, Ant-3, and Ant-4 mounted thereon. Accordingly, the reader antennas Ant-1, Ant-2, Ant-3, and Ant-4 which have recognized items send pieces of tagging information about the items to the RFID reader 140. The positions of the reader antennas Ant-1, Ant-2, Ant-3, and Ant-4 which have recognized the corresponding items can be known, and thus the positions of the electronic shelf units 110 in which the corresponding items are placed can also be known.

However, in the case where a plurality of reader antennas is mounted at short distance as in an electronic shelf environment, there may be a case where neighboring reader antennas recognize one tag at the same time. It may lead to a problem in accurately detecting the position of the corresponding tag. In order to solve the problem, the tag position detection algorithm is performed.

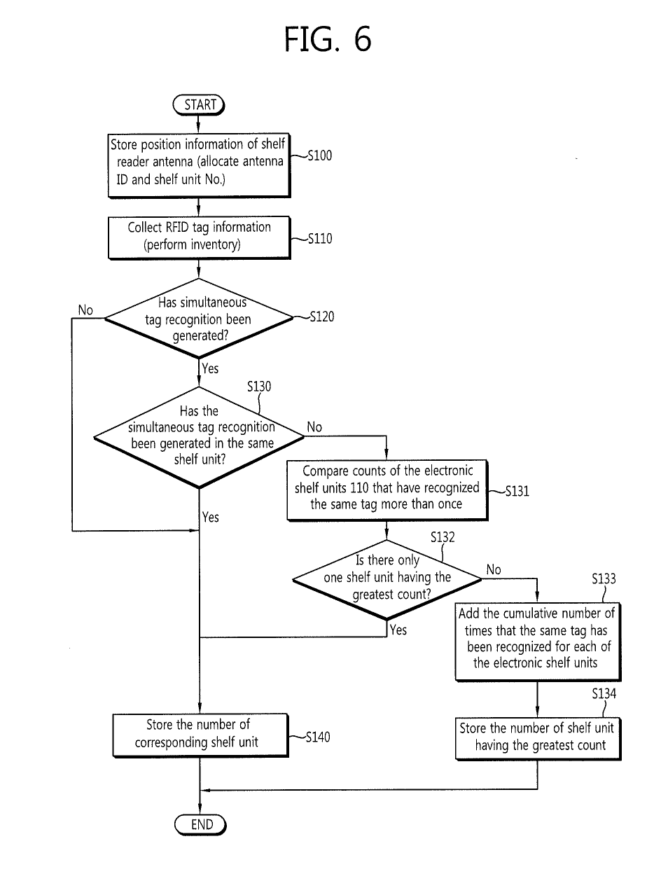

FIG. 6 is a diagram showing the tag position detection algorithm of the RFID electronic shelf apparatus according to an embodiment of the present invention. The tag position detection algorithm according to the embodiment of the present invention is used to determine the position of a tag in the case where a plurality of reader antennas recognizes one tag at the same time within the electronic shelf unit 110.

Referring to FIG. 6, at step S100, in order to detect the positions of items, a unique or other ID is allocated to each of the electronic shelf units 110 and reader antenna IDs are allocated to the respective reader antennas 131 and 132, belonging to the electronic shelf unit 110, through the user interface 250 when the shelf unit portion is first constructed, thereby data-filing real space information.

When a request to collect tagging information is received, the RFID reader 140 performs a tag inventory process at step S110. When the tagging information (i.e., a result of the tag inventory process) is transmitted from the RFID reader 140 to the RFID middleware 200, the tag position detection algorithm is performed. The tag position detection algorithm is performed by the item-based position detection processing unit 220, as described above.

First, the item-based position detection processing unit 220 determines whether each of the recognized tags has been simultaneously recognition at step S120. If, as a result of the determination, each of the recognized tags is determined not to have been simultaneously recognized, the item-based position detection processing unit 220 checks the reader antenna ID of each tag and stores information, indicating that the tag is placed in the electronic shelf unit 110 where a reader antenna corresponding to the reader antenna ID is installed, at step S140. The reader antenna ID may be mapped to space information, inputted when the RFID electronic shelf apparatus is first constructed, and may be displayed to a user through a two-dimensional or three-dimensional screen or displayed as a unique number.

However, if, as a result of the determination at step S120, any one of the recognized tags is determined to have been simultaneously recognized, the item-based position detection processing unit 220 determines whether the simultaneously recognized tag corresponds to reader antennas installed in the same electronic shelf unit 110 at step S130. If, as a result of the determination at step S130, the plurality of reader antennas installed in the same electronic shelf unit 110 is determined to have simultaneously recognized the corresponding tag, the item-based position detection processing unit 220 stores the position of the electronic shelf unit 110 in which the reader antennas that have recognized the corresponding tag are installed as information of a position in which the corresponding tag is placed at step S140.

If, as a result of the determination at step S130, the plurality of reader antennas installed in the same electronic shelf unit 110 is determined not to have simultaneously recognized the corresponding tag, it corresponds to a case where the reader antennas of different electronic shelf units 110 have redundantly recognized the tag placed in any one of the electronic shelf units 110. In this case, it is necessary to accurately check the position of the tag. To this end, each of the electronic shelf units 110 that have recognized the tag more than once counts the number of times that the corresponding tag is recognized, and the counts are compared with each other at step S131.

The item-based position detection processing unit 220 determines whether the number of electronic shelf units 110 having the greatest count is one at step S132. If, as a result of the determination, the number of electronic shelf units 110 having the greatest count is determined to be one, the item-based position detection processing unit 220 stores information about a position where the corresponding tag is placed in a specific electronic shelf unit 110 at step S140.

That is, since the number of reader antennas installed in each electronic shelf unit 110 is plural, a probability that the reader antennas of an electronic shelf unit 110 in which a tag is actually placed will redundantly recognize the corresponding tag is the highest. If the information about the electronic shelf unit 110 that has recognized the corresponding tag with the greatest count is stored as described, a probability that the corresponding electronic shelf unit 110 may be an electronic shelf unit 110 in which the corresponding tag is placed is the highest. Accordingly, the position of a tag can be accurately detected.

Meanwhile, if a tag is placed at the corner portion or other positions of an electronic shelf unit, there is a possibility that the reader antennas of other neighboring electronic shelf units 110 will redundantly recognize the corresponding tag. Furthermore, there is a possibility that the number of electronic shelf units 110 that has recognized the corresponding tag and has the same count may be plural.

If the number of electronic shelf units 110 having the greatest count is plural, that is, the counts that the plurality of electronic shelf units 110 has recognized the same tag are identical, the item-based position detection processing unit 220 adds the cumulative number of times that the same tag has been recognized for each of the electronic shelf units 110 that have recognized the same tag at step S133. The item-based position detection processing unit 220 determines that the same tag is placed in the electronic shelf unit 110 having the greatest number of times of recognition and stores tag position information at step S134. Here, the cumulative number of times may be a count from before or may be a count repeatedly obtained by each of the electronic shelf units 110.

The above tag recognition and position check process is performed in the RFID middleware 200 after the tag inventory process for the electronic shelf unit 110 is finished. Accordingly, position information of a tag, having the highest probability, and position information about the electronic shelf unit 110 close to the corresponding tag can be provided to the user.

In the embodiment of the present invention, when the position of each item is detected, the unit region of the electronic shelf unit 110 may be first detected. Next, the regions where the plurality of electronic shelf units 110 are included or the directions of the wall faces (e.g., the directions of the front, rear, left, and right wall faces) where the electronic shelf unit 110 is disposed may be distinguished. Such position detection resolution may be set by a user or may be randomly set for every electronic shelf unit 110.

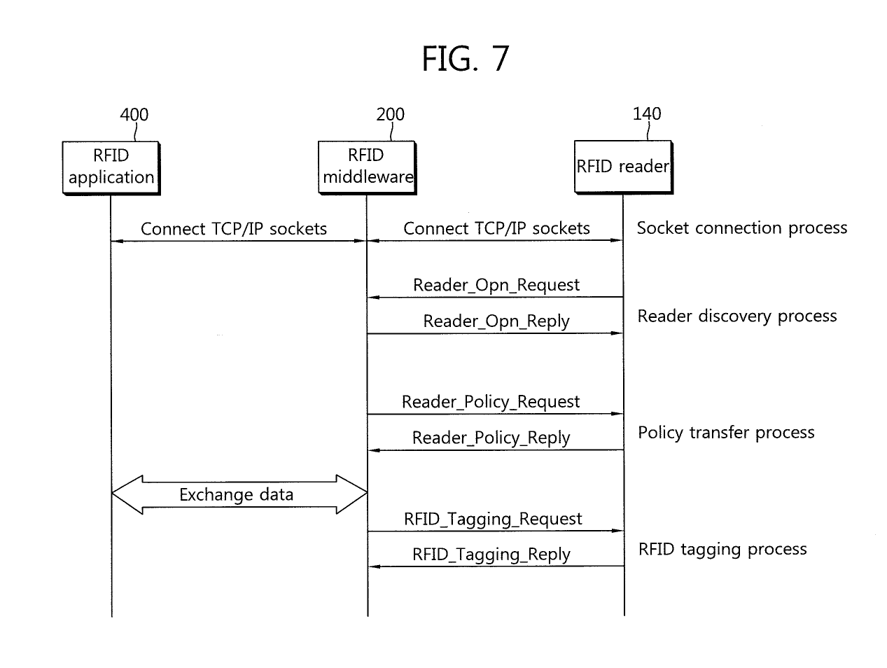

FIG. 7 shows an operational procedure of the RFID electronic shelf apparatus according to an embodiment of the present invention. As shown in FIG. 7, the RFID electronic shelf apparatus application system basically includes three parts, the RFID application 400, the RFID middleware 200, and the RFID reader 140 in terms of the operation.

In order to operate the RFID electronic shelf apparatus application system, a TCP/IP socket connection process of connecting the RFID application 400 and the RFID middleware 200 using Ethernet and the RFID middleware 200 and the RFID reader 140 using Ethernet, opening TCP/IP sockets, and performing communication is performed. Next, a reader discovery process is performed in which the RFID reader 140 requests reader opening from the RFID middleware 200 (Reader_Opn_Request) and the RFID middleware 200 sends a response (Reader_Opn_Reply) to the RFID reader 140 in response to the request.

Next, a policy transfer process is performed. In the policy transfer process, the RFID middleware 200 requests a reader policy from the RFID reader 140 (Reader_Policy_Request), and the RFID reader 140 sends a response (Reader_Policy_Reply) to the RFID middleware 200. Next, an RFID tagging process is performed on the basis of the corresponding policy. In the RFID tagging process, when the RFID middleware 200 requests RFID tagging from the RFID reader 140 (RFID_Tagging_Request), the RFID reader 140 performs tagging and sends an RFID tagging response (RFID_Tagging_Reply) to the RFID middleware 200. During the above process, electronic shelf item tagging information requests and responses, a policy, such as periodic tagging execution time, and other necessary data are exchanged between the RFID application 400 and the RFID middleware 200.

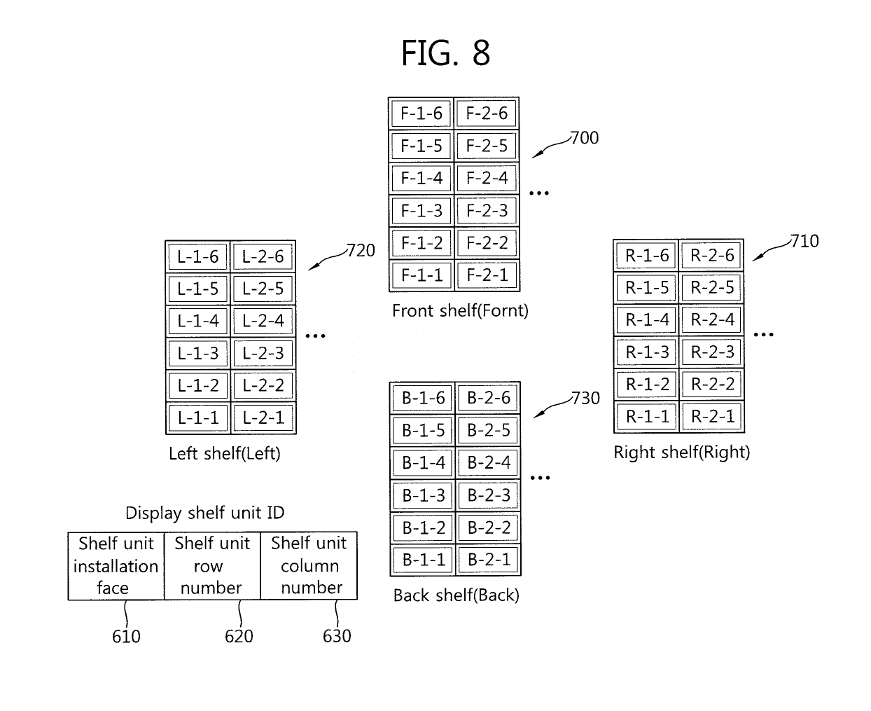

FIG. 8 shows the configurations of the RFID electronic shelf units and a numbering conceptual diagram according to an embodiment of the present invention. As shown in FIG. 8, the ID of one electronic shelf unit may include the ID of a shelf unit installation face 610, the ID of a shelf unit row number 620, and the ID of a shelf unit column number 630 in this order. The shelf unit installation face 610 may be classified into, for example, the front, back, left, and right which are indicated by respective characters F, B, L, and R.

Each of the shelf unit row number 620 and the shelf unit column number 630 may be indicated by an integer starting from 1. A reader ID corresponding to a shelf unit may be separately managed. FIG. 8 shows an embodiment in which the shelf portion 100 includes a total of the 48 electronic shelf units 110, wherein the electronic shelf units 110 of each of a front shelf unit 700, a rear shelf portion 730, a left shelf portion 720, and a right shelf portion 710 are arranged in 2 rows and 6 columns.

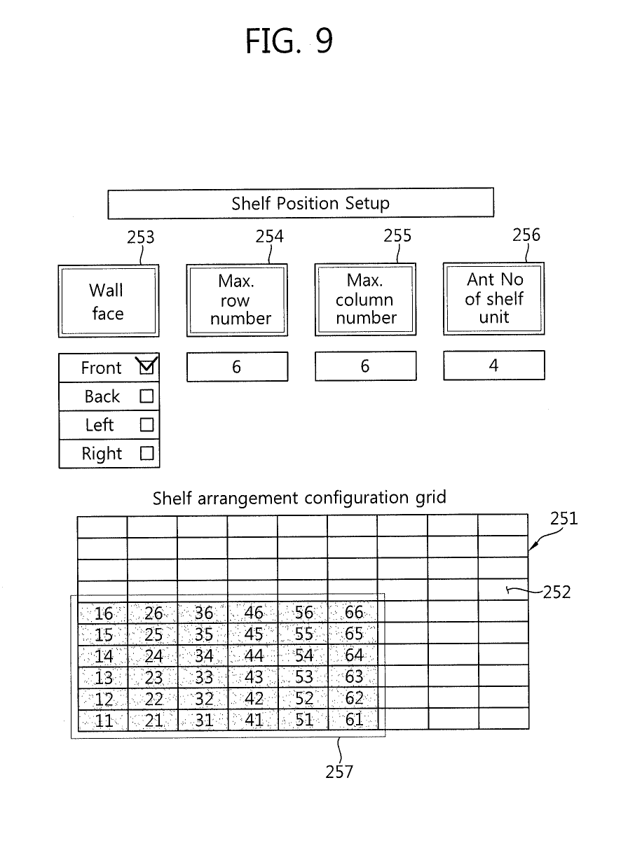

FIG. 9 is a diagram showing the user interface of the RFID electronic shelf apparatus according to an embodiment of the present invention. As shown in FIG. 9, the user interface 250 displays the configuration of all the shelf portions 100 in the form of a grid 251. In the grid 251, each of quadrangle lattices 252 may refer to one electronic shelf unit 110.

A user can select the electronic shelf units 110 of a specific region 257 in a bundle by selecting a wall face in which the shelf portion 100 is constructed (253), setting a maximum row number and a maximum column number of the electronic shelf units 110 to be disposed (254 and 255), and setting the number of reader antennas embedded in one electronic shelf unit 110 (256). Tagging and other operations for the electronic shelf units 110 of the specific region 257 can be performed in a bundle based on the above setting.

In accordance with the RFID electronic shelf apparatus and the method of detecting the positions of tags using the same according to the embodiments of the present invention, in a shelf portion that may be constructed on a large scale, lattices are constructed in the unit of the electronic shelf unit. Accordingly, there is an advantage in that the data filing and structuring for the configuration of the shelf portion can be simplified. Furthermore, since a user can display the data-filed and structured information in the 2D or 3D. Accordingly, the RFID electronic shelf apparatus can be effectively operated.

Furthermore, the RFID electronic shelf apparatus and the method of detecting the positions of tags using the same according to the present invention have advantages of stability and accuracy in the transmission of information, reduced configuration costs, and efficient store management by solving the shadow region of an electric wave due to the stacking of items within an electronic shelf and the close arrangement of the items.

Furthermore, in the RFID electronic shelf apparatus and the method of detecting the positions of tags using the same according to the present invention, the tag position detection algorithm for solving a problem that one tag is mistaken for multiple tags when an accurate position of an item is to be detected is used. Accordingly, in the case where shelves are constructed in various forms at real stores, the shelves can be easily managed. Furthermore, there are advantages in that there are provided a user interface method of enabling a user to easily set the configuration of shelves and a function of automatically finding a reader can be provided, and the operation of a reader can be managed according to a policy.

While the invention has been shown and described with respect to the preferred embodiments, it will be understood by those skilled in the art that various changes and modifications may be made without departing from the spirit and scope of the invention as defined in the following claims.

What is claimed is:

1. A Radio Frequency IDentification (RFID) electronic shelf apparatus, comprising:
electronic shelf units stacked and each the electronic shelf unit configured to have a plurality of reader antennas;
a reader configured to recognize the electronic shelf units individually or in a group in order to recognize a tag included in the electronic shelf unit; and
a position detection processing unit configured to group the plurality of reader antennas, included in the electronic shelf unit, and to obtain position information about the electronic shelf unit on which the tag is stacked based on tagging information provided by the reader.

2. The RFID electronic shelf apparatus as claimed in claim 1, wherein the reader antennas are installed on one or more of internal faces of the electronic shelf unit.

3. The RFID electronic shelf apparatus as claimed in claim 1, wherein connection holes for connecting the reader antenna are formed in the electronic shelf unit.

4. The RFID electronic shelf apparatus as claimed in claim 1, wherein each of the electronic shelf units includes an ID of a shelf unit installation face, an ID of a shelf unit row number, and an ID of a shelf unit column number.

5. A method of detecting a position of a tag in an RFID electronic shelf apparatus including a plurality of electronic shelf units and having a plurality of reader antennas included in each of the electronic shelf units, the method comprising:
a tag inventory step;
a step of determining whether simultaneous recognition for the tag has been generated in the plurality of electronic shelf units; and
if, as a result of the determination, the simultaneous recognition for the tag is determined to have been generated in the electronic shelf units, acquiring position information about the tag by comparing counts that the electronic shelf units have recognized the tag.

6. The method as claimed in claim 5, wherein if, as a result of the determination, the simultaneous recognition for the tag is determined not to have been generated in the electronic shelf units, information, indicating that the tag is placed in an electronic shelf unit that has recognized the tag, is stored.

7. The method as claimed in claim 5, wherein if the reader antennas which have recognized the tag are placed in an identical electronic shelf unit, the tag is determined to be placed in the electronic shelf unit in which the reader antennas are installed.

8. The method as claimed in claim 7, wherein if a number of the electronic shelf units which have recognized the tag more than once is plural, a number of times that the tag has been recognized is accumulated in each of the electronic shelf units which have recognized the tag more than once, and the tag is determined to be placed in an electronic shelf unit having a greatest cumulative number.

9. An RFID electronic shelf unit, comprising:
a top, a bottom, and lateral faces configured to form an external appearance;
at least one bottom reader antenna provided at the bottom; and
at least one lateral reader antenna provided in at least one of the top and the lateral faces.

10. The RFID electronic shelf unit as claimed in claim 9, wherein the bottom reader antenna includes at least one thin film-type antenna.

11. The RFID electronic shelf unit as claimed in claim 9, wherein the lateral reader antenna includes a dipole antenna.

12. The RFID electronic shelf unit as claimed in claim 9, wherein at least one connection hole for connecting the reader antennas is formed in at least one of the top and the lateral faces.
